(19) United States
(12) Patent Application Publication
(10) Pub. No.: US 2025/0075501 A1
(43) Pub. Date: Mar. 6, 2025

(54) ASPHALT-BASED NANO-COMPOSITE ROOFING PRODUCT

(71) Applicant: TAMKO Building Products LLC, Galena, KS (US)

(72) Inventors: Cyril Chevillard, Carl Junction, MO (US); Gizem Reese, Joplin, MO (US); Chris Freeborg, Joplin, MO (US); David Humphreys, Joplin, MO (US)

(21) Appl. No.: 18/462,033

(22) Filed: Sep. 6, 2023

(51) Int. Cl. E04D 1/20; C08K 3/04; C08K 3/40; C09D 7/61; C09D 7/63; C09D 195/00; E04D 1/28

(52) U.S. Cl. CPC E04D 1/20; C08K 3/042; C08K 3/40; C09D 7/61; C09D 7/63; C09D 195/00; E04D 1/28

(57) ABSTRACT

Asphalt-based nano-composite roofing products and methods of forming asphalt-based nano-composite roofing products are provided. An asphalt-based nano-composite roofing product may comprise a substrate layer, comprising a top surface and a bottom surface, and an asphalt coating layer, positioned over the top surface of the substrate layer. The substrate layer and/or the asphalt coating layer may comprise graphene dispersed therewithin.

### BACKGROUND

### Technical Field

Embodiments of the present disclosure relate to asphalt-based nano-composite roofing products having graphene dispersed therewithin, and methods of forming asphalt-based nano-composite roofing products having graphene dispersed therewithin.

### Background

In the manufacture of roofing, various coating materials may be used to form an outer coating of the roofing. These materials may comprise asphalt used in the manufacture of roofing, polymer, acid modifiers, limestone, asphalt blending modifiers such as petroleum resin and wax, and/or other suitable materials for use in the manufacture of roofing.

Graphene, which consists of carbon atoms arranged in a hexagonal lattice, has been the subject of many publications and has shown excellent mechanical strength, higher thermal and electrical conductivity, hydrophobic properties, and high impermeability to gas. Depending on the mode of fabrication, graphene may exist as a single layer, called pristine graphene, or as multilayer structures, called graphene nanoplatelets (10 to 3000 layers). The layers may be stacked or slightly offset, forming turbostratic graphene.

### SUMMARY

According to an object of the present disclosure, an asphalt-based nano-composite roofing product is provided. The asphalt-based nano-composite roofing product may comprise a substrate layer, comprising a top surface and a bottom surface, and an asphalt coating layer, positioned over the top surface of the substrate layer. The substrate layer and/or the asphalt coating layer may comprise graphene dispersed therewithin.

According to various embodiments, the graphene may comprise one or more of the following: graphene powder (GP); graphene nanoplatelets (GNP); and graphene nanoplatelet aggregates (GNP-Agg).

According to various embodiments, the substrate layer may comprise a plurality of glass fibers and a thermoset configured to bind together the plurality of glass fibers and the graphene. The graphene may be dispersed within the thermoset.

According to various embodiments, the thermoset may comprise urea formaldehyde.

According to various embodiments, the asphalt-based nano-composite roofing product may further comprise a reinforcement layer, positioned over the bottom surface of the substrate layer.

According to various embodiments, the reinforcement layer may comprise a mat.

According to various embodiments, the mat may comprise a plurality of polyethylene terephthalate (PET) fibers and a binder configured to bind together the plurality of PET fibers.

According to various embodiments, the binder may comprise graphene dispersed therewithin.

According to an object of the present disclosure, an asphalt-based nano-composite roofing product is provided. The asphalt-based nano-composite roofing product may comprise a substrate layer, comprising a top surface and a bottom surface, an asphalt coating layer, positioned over the top surface of the substrate layer, and a reinforcement layer, positioned over the bottom surface of the substrate layer. The reinforcement layer may comprise a mat. The mat may comprise a plurality of polyethylene terephthalate (PET) fibers and a binder configured to bind together the plurality of PET fibers. The binder may comprise graphene dispersed therewithin.

According to various embodiments, the graphene may comprise one or more of the following: graphene powder (GP); graphene nanoplatelets (GNP); and graphene nanoplatelet aggregates (GNP-Agg).

According to various embodiments, the asphalt coating layer may comprise the graphene dispersed therewithin.

According to various embodiments, the substrate layer may comprise a plurality of glass fibers, a thermoset configured to bind together the plurality of glass fibers and the graphene, wherein the graphene is dispersed within the thermoset.

According to various embodiments, the thermoset may comprise urea formaldehyde.

According to an object of the present disclosure, a method for forming an asphalt-based nano-composite roofing product is provided. The method may comprise forming a substrate layer. The process of forming the substrate layer may comprise dispersing glass fibers in water, generating a fiber slurry, dispersing the fiber slurry onto a conveyor belt, generating a web, dispersing graphene within a binder, applying the binder to the web, forming a web-binder mixture, and chemically curing the web-binder mixture. The binder may be configured to bind together the glass fibers. The substrate layer may comprise a top surface and a bottom surface. The method may further comprise applying an asphalt coating layer over the top surface of the substrate layer.

According to various embodiments, the method may further comprise partially dewatering the web-binder mixture prior to chemically curing the web-binder mixture.

According to various embodiments, the chemically curing the web-binder mixture may comprise chemically curing the web-binder mixture using heat.

According to various embodiments, the graphene may comprise one or more of the following: graphene powder (GP); graphene nanoplatelets (GNP); and graphene nanoplatelet aggregates (GNP-Agg).

According to various embodiments, the dispersing the graphene within the binder may comprise applying one or more of sonication and agitation to a mixture of the graphene and the binder.

According to various embodiments, the method may further comprise forming a reinforcement layer. Forming the reinforcement layer may comprise dispersing a plurality of polyethylene terephthalate (PET) fibers onto a conveyor belt, forming a PET web, mechanically interlocking the plurality of PET fibers by punching one or more needles through the PET web, applying heat to the PET web, fusing the plurality of PET fibers in the PET web together, applying the binder to the PET web, generating a PET web-binder mixture, and chemically curing the PET web-binder mixture. The binder may be configured to bind together the plurality of PET fibers.

According to various embodiments, the method may further comprise applying the reinforcement layer over the bottom surface of the substrate layer.

According to various embodiments, the method may further comprise calendering the PET web prior applying the binder to the PET web.

According to various embodiments, the binder may comprise a waterborne thermoplastic styrene acrylic polymer binder.

According to various embodiments, dispersing the graphene within the binder may comprise applying one or more of sonication and agitation to a mixture of the graphene and the binder.

### BRIEF DESCRIPTION OF THE DRAWINGS

The accompanying drawings, which are incorporated in and form a part of the Description of Embodiments, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1A illustrates an upper perspective view of an asphalt-based nano-composite roofing product, according to an embodiment of the present disclosure.

FIG. 1B illustrates a lower perspective view of an asphalt-based nano-composite roofing product, according to an embodiment of the present disclosure.

FIG. 1C illustrates a side view of an asphalt-based nano-composite roofing product, according to an embodiment of the present disclosure.

FIG. 2 illustrates a scanning electron microscope image of a glass mat composite with a chemical binder bounding a plurality of glass fibers, according to an embodiment of the present disclosure.

FIGS. 3A-3B illustrates a method of forming an asphalt-based nano-composite roofing product, according to an embodiment of the present disclosure.

FIG. 4 illustrates a method of forming a reinforcement layer of an asphalt-based nano-composite roofing product, according to an embodiment of the present disclosure.

FIG. 5 illustrates a graph of a complex modulus ratio of aged versus un-aged material, according to an embodiment of the present disclosure.

### DETAILED DESCRIPTION

The following Description of Embodiments is merely provided by way of example and not of limitation. Furthermore, there is no intention to be bound by any expressed or implied theory presented in the preceding background or in the following Detailed Description.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

An “electronic device” or a “computing device” refers to a device that comprises a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the terms “about” and “approximately” are understood as within a range of normal tolerance in the art, for example within 2 standard deviations of the mean. “About” and “approximately” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the terms “about” and “approximately”.

Hereinafter, embodiments disclosed in this specification will be described in detail with reference to the accompanying drawings, and the same or similar elements will be given the same reference symbols regardless of drawing numbers, and redundant description thereof will be omitted. In addition, a detailed description of well-known features or functions will be ruled out in order not to unnecessarily obscure the gist of the present disclosure.

In the following description, the terms “module” and “unit” for referring to elements are assigned and used interchangeably in consideration of convenience of explanation, and thus, the terms per se do not necessarily have different meanings or functions. Further, in describing the embodiments disclosed in the present specification, when it is determined that a detailed description of a related publicly known technology may obscure the gist of the embodiments disclosed in the present specification, the detailed description thereof will be omitted. In addition, the accompanying drawings are used to help easily understand the embodiments disclosed in this specification, the technical idea disclosed in this specification is not limited by the accompanying drawings, and it should be understood that all alterations, equivalents, and substitutes included in the spirit and scope of the present disclosure are included herein.

Although terms including ordinal numbers, that is, “first”, “second”, etc. may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Embodiments of the present disclosure pertain to asphalt-based nano-composite roofing products having graphene dispersed therewithin, and systems and methods of forming asphalt-based nano-composite roofing products having graphene dispersed therewithin.

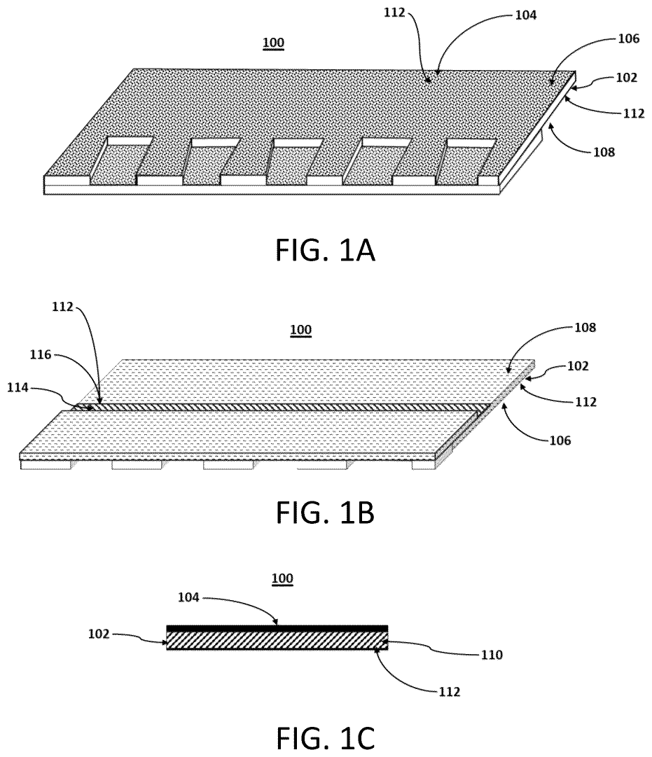

Referring now to FIGS. 1A-1C, an upper perspective view (FIG. 1A), a lower perspective view (FIG. 1B), and a side view (FIG. 1C) of an asphalt-based nano-composite roofing product 100 are illustratively depicted, in accordance with an embodiment of the present disclosure.

The asphalt-based nano-composite roofing product 100 may comprise a substrate layer 102 and an asphalt coating layer 104. The substrate layer 102 may comprise a top surface 106 and a bottom surface 108. The asphalt coating layer 104 may be positioned over the top surface 106 of the substrate layer 102.

According to various embodiments, the substrate layer 102 or the asphalt coating layer 104 comprise graphene dispersed therewithin. According to various embodiments, both the substrate layer 102 and the asphalt coating layer 104 comprise graphene dispersed therewithin. According to various embodiments, the graphene may comprise graphene oxide (GO), graphene powder (GP), graphene nanoplatelets (GNP), and/or graphene nanoplatelet aggregates (GNP-Agg). It is noted, however, that other suitable forms of graphene may be incorporated, while maintaining the spirit and functionality of the present disclosure. Graphene characteristics for example, but not limiting, graphene used in conjunction with the present disclosure is shown, e.g., in Table 1.

TABLE 1

| | Bulk | | | Surface | O₂ |
|---|---|---|---|---|---|
| | Density | Width | Thickness | Area | Content |
| Graphene Name | (g/cc) | (μm) | (nm) | (m²/g) | (wt %) |
| Graphene Oxide (GO) | | 1.0-15.0 | 0.8-1.2 | 5.0-10.0 | 50.0 |
| Graphene Powder (GP) | | 0.5-5.0 | 0.34-1.7 | 650.0-750.0 | <2.0 |
| Graphene Nanoplatelet | 0.03-0.1 | <2.0 | <4.0 | 120.0-150.0 | <2.0 |
| Aggregates (GNP-Agg) | | | | | |
| Graphene Nanoplatelet (GNP) | 0.2-0.4 | 5.0 | 6.0-8.0 | 300.0 | <2.0 |

According to various embodiments, the graphene may comprise surface coverage that ranges from approximately 15 m²/g to approximately 1000 m²/g. According to various embodiments, the graphene may comprise an oxygen content from approximately 2 wt % (e.g., for pristine and nanoplatelet graphene (GNP)) to approximately 50 wt % (e.g., for graphene oxide (GO)). It is noted, however, that graphene having other surface coverage ranges and/or wt % ranges may be incorporated, while maintaining the spirit and functionality of the present disclosure.

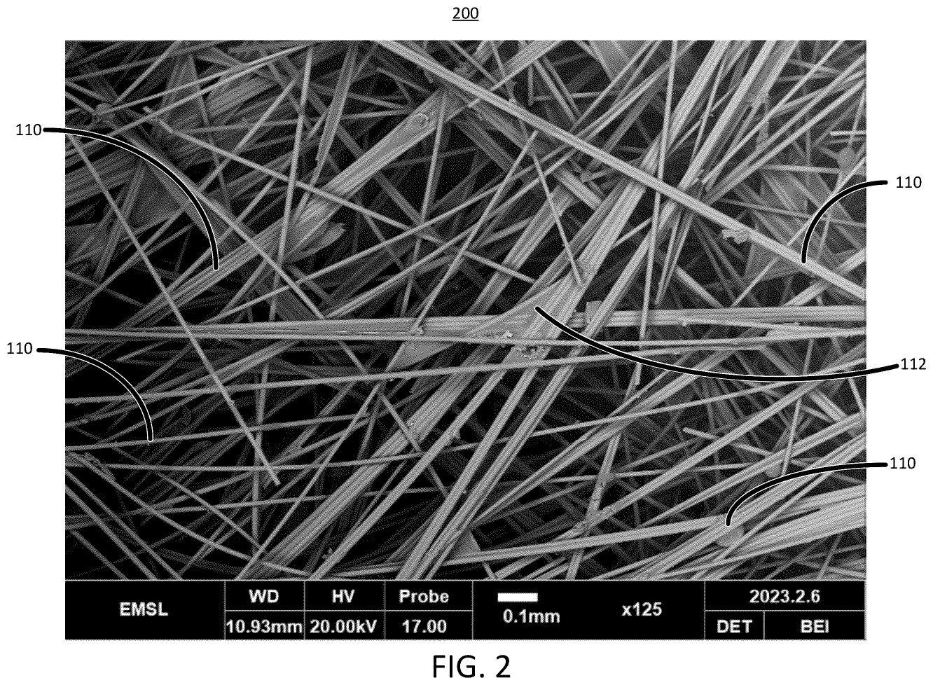

According to various embodiments, the substrate layer 102 may comprise a plurality of glass fibers 110, as shown, e.g., in FIG. 2, illustrating a scanning electron microscope image of a glass mat composite 200 with a chemical binder bounding a plurality of glass fibers 110 and graphene. According to various embodiments, the graphene may be dispersed within the chemical binder (e.g., the mixture 112 of graphene and chemical binder shown, e.g., in FIG. 2).

According to various embodiments, the chemical binder may comprise urea formaldehyde, a waterborne styrene-acrylic polymer, and/or other suitable chemical binders. According to various embodiments, the binder may comprise a thermoplastic styrene acrylic polymer binder. The thermoplastic binder may comprise a crosslinking agent that may comprise two or more reactive functional groups designed to chemically cure the binder using heat. The chemical component may comprise melamine formaldehyde.

The chemical binder may be configured to bind together the plurality of glass fibers 110 and the graphene. According to various embodiments, the chemical binder may be configured to chemically cure using heat. It is noted, however, that the chemical binder may be configured to chemically cure using other suitable means, while maintaining the spirit and functionality of the present disclosure. According to various embodiments, the chemical binder, once cured, may be configured to take on one or more characteristics of a thermoset and, in the cured form, may be referred to as a thermoset.

According to various embodiments, the asphalt-based nano-composite roofing product 100 may comprise a reinforcement layer 114. The reinforcement layer 114 may be positioned over the bottom surface 108 of the substrate layer 102. It is noted, however, that the reinforcement layer 114 may be positioned at other suitable positions along the substrate layer 102, while maintaining the spirit and functionality of the present disclosure.

The reinforcement layer 114 may comprise a mat 116. The mat 116 may comprise one or more polyethylene terephthalate (PET) fibers. The mat 116 may comprise a chemical binder configured to bind together the plurality of PET fibers. According to various embodiments, the binder used to bind together the plurality of PET fibers may be the same binder used to bind together the plurality of glass fibers and/or one or more other suitable binders. According to various embodiments, the binder used to bind together the plurality of PET fibers may comprise graphene dispersed therewithin. According to various embodiments, the graphene may comprise graphene oxide (GO), graphene powder (GP), graphene nanoplatelets (GNP), and/or graphene nanoplatelet aggregates (GNP-Agg). It is noted, however, that other suitable forms of graphene may be incorporated, while maintaining the spirit and functionality of the present disclosure.

According to various embodiments, the chemical binder used to bind together the plurality of PET fibers may be configured to chemically cure using heat. It is noted, however, that the chemical binder used to bind together the plurality of PET fibers may be configured to chemically cure using other suitable means, while maintaining the spirit and functionality of the present disclosure. According to various embodiments, the chemical binder used to bind together the plurality of PET fibers, once cured, may be configured to take on one or more characteristics of a thermoset and, in the cured form, may be referred to as a thermoset.

The dispersion of graphene presents several benefits to the asphalt-based nano-composite roofing product 100, as described, for example, below.

During a process for manufacturing shingle, temperatures may reach between 232° C. (480F) to 100° C. (212° F.). During this process, a granulated sheets of the shingle may be subjected to high tension, and the mechanical strength of a filled asphalt coating decreases with temperature. Due to this decrease in mechanical strength, excessive tension may translate to sheet breakage, leading to downtime and increased cost. Additionally, during the roofing process, shingles are handled manually and can be torn. The torn sheets will have to be replaced, leading to increased cost.

Generally, to overcome these downfalls, a glass mat thickness and, therefore, the sheet weight, are increased. These increases lead to higher production and logistic costs. However, the introduction of graphene aids in minimizing sheet breakage and tear damage while minimizing the downfalls of increased glass mat thickness and sheet weight.

According to various embodiments, a reinforced graphene-based asphalt coating may be incorporated. The mechanical strength of the graphene-based asphalt coating is increased significantly, over non-graphene-based asphalt coating, for every percent of graphene added to the mix (e.g., see Table 2 and Table 3). Additionally, the dispersion of the graphene strengthens the sheet over a broad range of temperatures, leading to lower sheet breakage and improved shingle tear performance.

TABLE 2

| | | % Modulus |
|---|---|---|
| | G* [Pa]@ | Increase /% |
| | 100° C. | additive added |
| Complex Modulus @100° C. (212° F.) | (212° F.) | to the mix |
| Asphalt Coating | 8271 | |
| Asphalt Coating with 55 wt % limestone | 50949 | 10% |
| Asphalt Coating with 10 wt % GNP- | 31006 | 30% |
| Agg | | |
| Asphalt Coating with 10 wt % GNP | 90558 | 100% |
| Asphalt Coating with 1 wt % GP | 28469 | 240% |

TABLE 3

| | | % Modulus |
|---|---|---|
| Complex Modulus | G* [Pa]@ | Increase /% |
| @25° C. | 25° C. | additive added |
| (77° F.) | (77° F.) | to the mix |
| Asphalt Coating | 9.6 10⁶ | |
| Asphalt Coating with 55 wt % | 4.4 10⁷ | 6.5% |
| limestone | | |
| Asphalt Coating with 10 wt % GNP- | 3.2 10⁷ | 6.5% |
| Agg | | |
| Asphalt Coating with 10 wt % GNP | 1.6 10⁷ | 23% |
| Asphalt Coating with 1 wt % GP | 1.7 10⁷ | 80% |

According various embodiments, a glass mat with reinforced chemical binder may be incorporated. The glass mat is an important component of asphalt-based singles and serves as a support structure. The glass mat consists of glass fibers bound together with a thermoset (e.g., Urea Formaldehyde (UF)). According to various embodiments, the addition of graphene to the glass mat increases bond strength of the thermoset, leading to higher tensile and tear strength.

According to various embodiments, graphene base sizing chemistry may be used as a surface modifier for the glass fibers. The interaction between the asphalt and the glass fibers is critical in shingle strength. Such interaction represents 20-30% of the shingle tear performance. Graphene, which is carbon-based and hydrophobic by nature, is chemically close to asphalt and can provide a more favorable interface, promoting asphalt-glass adhesion and creating a stronger bond between the two, leading to greater shingle strength.

According to various embodiments, a reinforcing layer may be added to shingles (e.g., along a back side of the shingle) to strengthen the shingle's structure and increase the shingle's ability to sustain powerful winds (e.g., up to 200 miles/hour). The reinforced layer is a non-woven PET fiber mat bonded with a thermoplastic or thermoset binder designed to hold the PET fibers in place, giving strength to the mat. To achieve the required strength the mat needs to be processed and cured at a minimum target weight. The mat strength may be enhanced by incorporating graphene into the binder as well as to the PET fibers, leading to lower mat weight.

According to various embodiments, a PET mat with a reinforced thermoplastic and/or thermoset binder may be used. Similar to incorporation with a glass mat, graphene may be dispersed into the binder (e.g., by sonication, agitation, and/or other suitable means). The new graphene-based binder increases the bond strength between the PET fibers, leading to higher tensile and tear strength for the mat. The new graphene-based binder may be added to the mat manufacturing process and cured similar to a standard binder.

According to various embodiments, PET fibers that constitute the mat may also be reinforced using graphene. Graphene-based PET, designed for fiber spinning, may be used to strengthen the mat for this application.

Thermal oxidation of asphalt is a chemical process that occurs slowly during the weathering process (aging) or violently during combustion (fire), leading to the degradation of asphalt-based shingles. To minimize the long-term aging process of shingles, the asphalt chemical composition needs to be carefully selected, either by finding a desired sourcing or by mixing various asphalts. To pass fire code ASTM D3462, asphalt-based shingles have to be designed with the lowest amount of asphalt, which can be detrimental to quality.

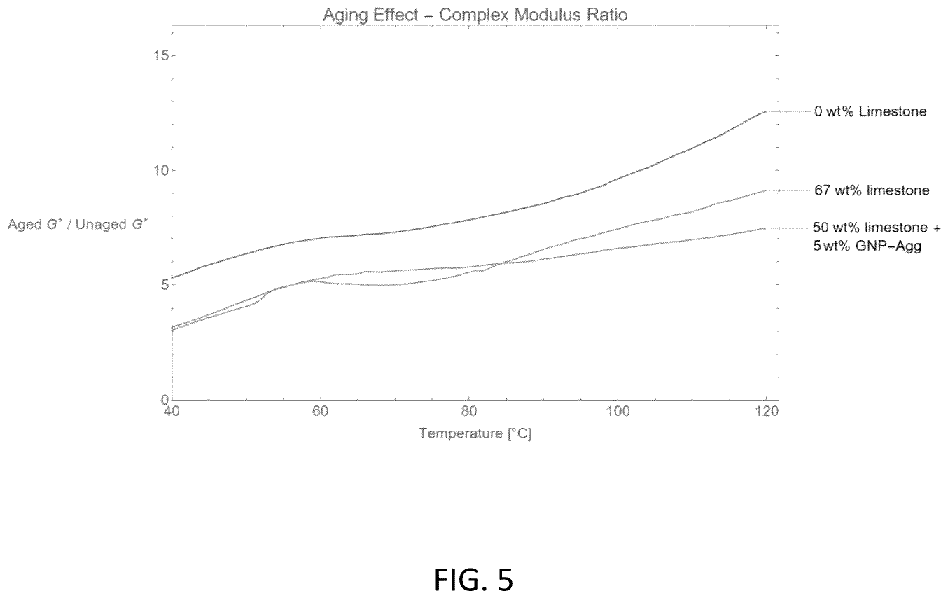

Regarding thermal oxidation stability, as temperature increases, shingle material undergoes chemical decomposition. This leads to a mass decrease. Compares to a typical asphalt coating, which loses 99 wt % of its mass at 600° C., graphene by itself is relatively stable and loses only 22 wt % of its own mass at 600° C. When graphene is mixed with an asphalt coating, the graphene slows down the thermal oxidation process, making the asphalt-based roofing material more durable to thermal oxidation and weathering. Such behavior can also be observed by charting the complex modulus ratio of aged versus un-aged material, as shown, e.g., in FIG. 5, which maps asphalt with 0 wt % limestone, 67 wt % limestone, and a combination of 50 wt % limestone and 5 wt % GNP-Agg.

Polymer Modified Asphalt (PMA) may be used as a sealant or laminate or asphalt-based adhesive, and is generally made by mixing a compatible base asphalt with styrene butadiene co-polymers. This results in a finished product that is tackier, softer, and more flexible and can conform and stick to most relevant surfaces. However, for roofing products, which are subjected to high winds, a material that is too elastic may deform excessively and fail to maintain its structural integrity (e.g., cohesive failure). On the other hand, a material that is too stiff may not be able to conform to the surface that it is supposed to be in contact with and will fail to adhere properly.

To overcome the stiffness/flexibility challenge, the sealant or laminate has to be designed by selecting the right asphalt-based and/or polymer package or/and by adding a large amount of limestone. Limestone is a porous material and tends to “dry” the asphalt, leading to poorer adhesion.

According to various embodiments, for every percent of limestone added to the base material, it takes 4-10 times less graphene to achieve the same performance without the negative aspect of weight increase and absorption characteristics of the limestone.

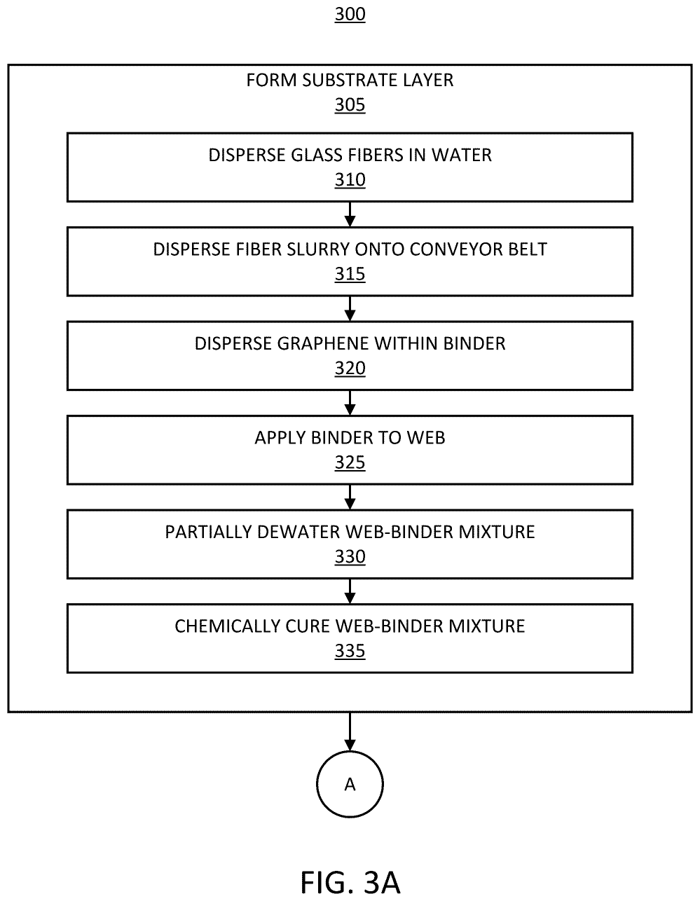

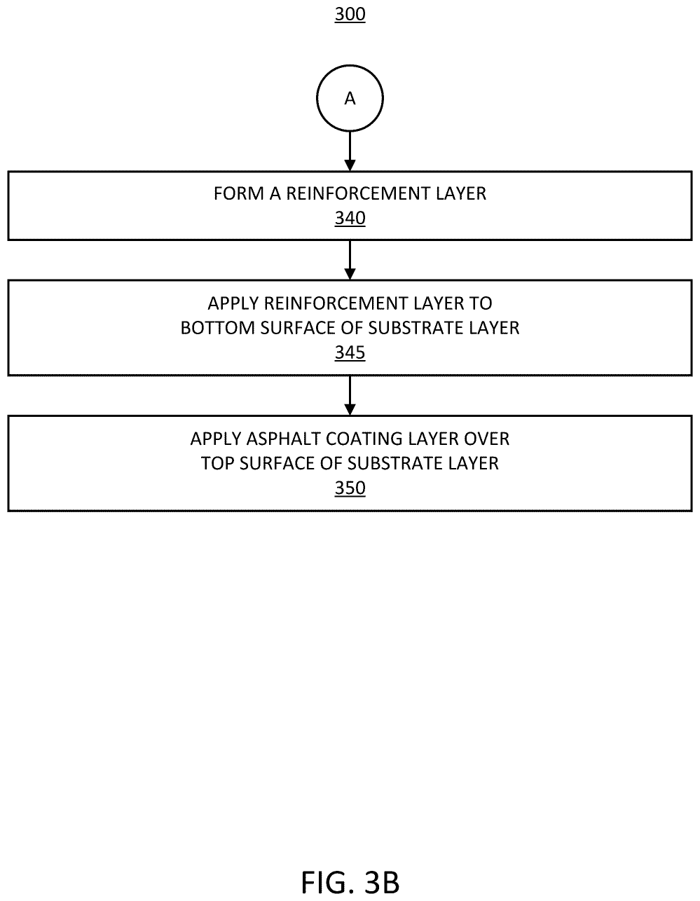

Referring now to FIGS. 3A-3B, a method 300 for forming an asphalt-based nano-composite roofing product is illustratively depicted, in accordance with an embodiment of the present disclosure.

At 305, a substrate layer is formed. The substrate layer may comprise a top surface and a bottom surface.

According to various embodiments, forming the substrate layer may comprise, at 310, dispersing a plurality of glass fibers in water, generating a fiber slurry.

According to various embodiments, forming the substrate layer may comprise, at 315, dispersing the fiber slurry onto a conveyor belt, generating a web.

According to various embodiments, forming the substrate layer may comprise, at 320, dispersing graphene within a binder. The binder may be configured to bind together the plurality of glass fibers. The binder may comprise urea formaldehyde. It is noted, however, that other suitable binders may be incorporated, while maintaining the spirit and functionality of the present disclosure.

According to various embodiments, the dispersing the graphene within the binder may comprise applying sonication and/or agitation to a mixture of the graphene and the binder. It is noted, however, that other suitable means of dispersing the graphene within the binder may be incorporated, while maintaining the spirit and functionality of the present disclosure.

According to various embodiments, the graphene may comprise graphene oxide (GO), graphene powder (GP), graphene nanoplatelets (GNP), and/or graphene nanoplatelet aggregates (GNP-Agg). It is noted, however, that other suitable forms of graphene may be incorporated, while maintaining the spirit and functionality of the present disclosure.

According to various embodiments, forming the substrate layer may comprise, at 325, applying the binder to the web, forming a web-binder mixture.

According to various embodiments, forming the substrate layer may comprise, at 335, chemically curing the web-binder mixture. Chemically curing the web-binder mixture may comprise chemically curing the web-binder mixture using heat. It is noted, however, that other means of chemically curing the web-binder mixture may be incorporated, while maintaining the spirit and functionality of the present disclosure. According to various embodiments, forming the substrate layer may comprise, at 330, partially dewatering the web-binder mixture prior to chemically curing the web-binder mixture.

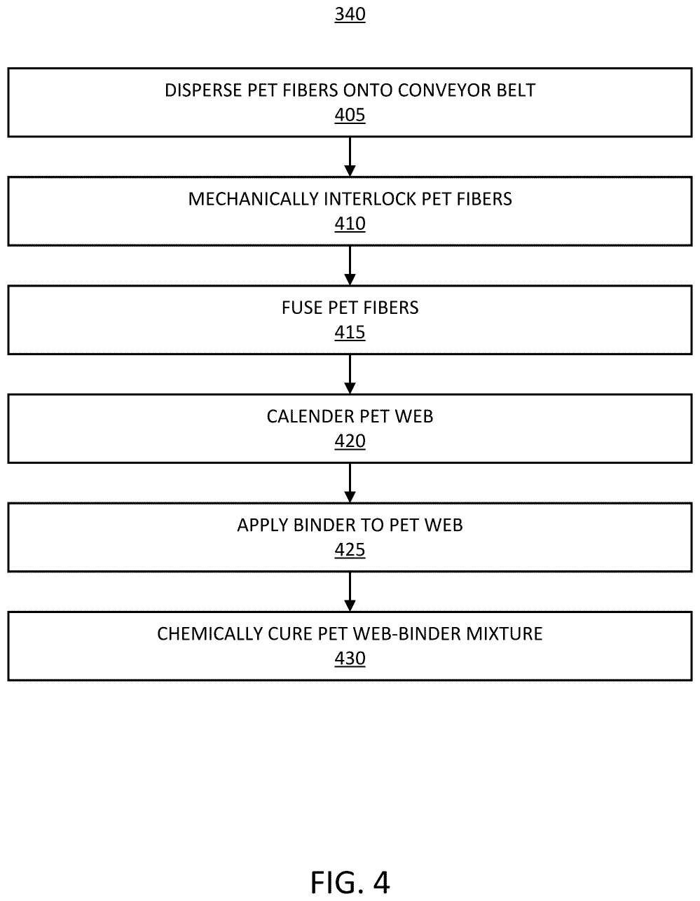

At 340, a reinforcement layer may be formed. As shown in FIG. 4, forming the reinforcement layer may comprise, at 405, dispersing a plurality of polyethylene terephthalate (PET) fibers onto a conveyor belt, forming a PET web. The plurality of PET fibers, at 410, may be mechanically interlocked by, e.g., punching one or more needles through the PET web. The plurality of PET fibers, at 415, may be fused. According to various embodiments, fusing the PET fibers may comprise applying heat to the PET web, fusing the plurality of PET fibers in the PET web together. According to various embodiments, the reinforcement layer may comprise a binder. The binder may comprise a waterborne styrene-acrylic polymer. It is noted, however, that other means of fusing the plurality of PET fibers may be incorporated, while maintaining the spirit and functionality of the present disclosure.

According to various embodiments, forming the reinforcement layer may comprise, at 425, applying a binder to the PET web, generating a PET web-binder mixture. The binder is configured to bind together the plurality of PET fibers. The binder may be the same binder used to bind together the plurality of glass fibers and/or one or more other suitable binders. According to various embodiments, the PET web, at 420, may be calendered prior to applying the binder to the PET web, at 425. According to various embodiments, the calendering, at 420, may comprise the fusing of the PET fibers, at 415.

According to various embodiments, forming the reinforcement layer may comprise, at 430, chemically curing the PET web-binder mixture, forming the reinforcement layer.

Referring back to FIG. 3B, at 345, the reinforcement layer may be applied over the bottom surface of the substrate layer.

At 350, an asphalt coating layer may be applied over the top surface of the substrate layer, forming the asphalt-based nano-composite roofing product.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims. The effects obtainable in the present disclosure are not limited to the above-mentioned effects, and other effects not mentioned herein may be clearly understood by those of ordinary skill in the art to which the present disclosure belongs from the above description.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems, methods, and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

The present disclosure described above may be implemented as computer-readable code on a medium in which a program is recorded. The computer-readable medium comprises all types of recording devices in which data readable by a computer system is stored. Examples of the computer-readable medium include a hard disk drive (HDD), a solid state drive (SSD), a silicon disk drive (SDD), a ROM, a RAM, a CD-ROM, a magnetic tape, a floppy disk, an optical data storage device, etc.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents. The features and functions described above, as well as alternatives, may be combined into many other different systems or applications. Various alternatives, modifications, variations or improvements may be made by those skilled in the art, each of which is also intended to be encompassed by the disclosed embodiments.

What is claimed is:

1. An asphalt-based nano-composite roofing product, comprising:
a substrate layer, comprising a top surface and a bottom surface; and
an asphalt coating layer, positioned over the top surface of the substrate layer,
wherein the substrate layer and the asphalt coating layer comprise graphene dispersed therewithin.

2. The asphalt-based nano-composite roofing product of claim 1, wherein the graphene comprises one or more of the following:
graphene powder (GP);
graphene nanoplatelets (GNP); and
graphene nanoplatelet aggregates (GNP-Agg).

3. The asphalt-based nano-composite roofing product of claim 1, wherein the substrate layer comprises:
a plurality of glass fibers; and
a thermoset configured to bind together the plurality of glass fibers and the graphene,
wherein the graphene is dispersed within the thermoset.

4. The asphalt-based nano-composite roofing product of claim 3, wherein the thermoset comprises urea formaldehyde.

5. The asphalt-based nano-composite roofing product of claim 1, further comprising a reinforcement layer, positioned over the bottom surface of the substrate layer.

6. The asphalt-based nano-composite roofing product of claim 5, wherein:
the reinforcement layer comprises a mat, and
the mat comprises:
a plurality of polyethylene terephthalate (PET) fibers; and
a binder configured to bind together the plurality of PET fibers.

7. The asphalt-based nano-composite roofing product of claim 6, wherein the binder comprises graphene dispersed therewithin.

8. An asphalt-based nano-composite roofing product, comprising:
a substrate layer, comprising a top surface and a bottom surface;
an asphalt coating layer, positioned over the top surface of the substrate layer; and
a reinforcement layer, positioned over the bottom surface of the substrate layer,
wherein:
the reinforcement layer comprises a mat, and
the mat comprises:
a plurality of polyethylene terephthalate (PET) fibers; and
a binder configured to bind together the plurality of PET fibers, the binder comprising graphene dispersed therewithin.

9. The asphalt-based nano-composite roofing product of claim 8, wherein the graphene comprises one or more of the following:
graphene powder (GP);
graphene nanoplatelets (GNP); and
graphene nanoplatelet aggregates (GNP-Agg).

10. The asphalt-based nano-composite roofing product of claim 8, wherein the asphalt coating layer comprises the graphene dispersed therewithin.

11. The asphalt-based nano-composite roofing product of claim 8, wherein the substrate layer comprises:
a plurality of glass fibers;
a thermoset configured to bind together the plurality of glass fibers and the graphene; and
the graphene, wherein the graphene is dispersed within the thermoset.

12. The asphalt-based nano-composite roofing product of claim 11, wherein the thermoset comprises urea formaldehyde.

13. A method for forming an asphalt-based nano-composite roofing product, comprising:
forming a substrate layer, comprising:
dispersing glass fibers in water, generating a fiber slurry;
dispersing the fiber slurry onto a conveyor belt, generating a web;
dispersing graphene within a binder;
applying the binder to the web, forming a web-binder mixture,
wherein the binder is configured to bind together the glass fibers; and
chemically curing the web-binder mixture,
wherein the substrate layer comprises a top surface and a bottom surface; and
applying an asphalt coating layer over the top surface of the substrate layer.

14. The method of claim 13, further comprising partially dewatering the web-binder mixture prior to chemically curing the web-binder mixture.

15. The method of claim 14, wherein the chemically curing the web-binder mixture comprises chemically curing the web-binder mixture using heat.

16. The method of claim 13, wherein the graphene comprises one or more of the following:
graphene powder (GP);
graphene nanoplatelets (GNP); and
graphene nanoplatelet aggregates (GNP-Agg).

17. The method of claim 13, wherein dispersing the graphene within the binder comprises applying one or more of sonication and agitation to a mixture of the graphene and the binder.

18. The method of claim 13, further comprising:
forming a reinforcement layer, comprising:
dispersing a plurality of polyethylene terephthalate (PET) fibers onto a conveyor belt, forming a PET web;
mechanically interlocking the plurality of PET fibers by punching one or more needles through the PET web;
applying heat to the PET web, fusing the plurality of PET fibers in the PET web together;
applying the binder to the PET web, generating a PET web-binder mixture,
wherein the binder is configured to bind together the plurality of PET fibers; and
chemically curing the PET web-binder mixture; and
applying the reinforcement layer over the bottom surface of the substrate layer.

19. The method of claim 18, further comprising calendering the PET web prior applying the binder to the PET web.

20. The method of claim 13, wherein the binder comprises a waterborne styrene-acrylic polymer.

21. The method of claim 20, wherein dispersing the graphene within the binder comprises applying one or more of sonication and agitation to a mixture of the graphene and the binder.
